(19) United States
(12) Patent Application Publication
(10) Pub. No.: US 2026/0112163 A1
(43) Pub. Date: Apr. 23, 2026

(54) EVENT DETECTION METHOD AND DEVICE BASED ON HIERARCHICAL STRUCTURE LINKED WITH MEMORY

(71) Applicant: AIMATICS CO., LTD, Seoul (KR)

(72) Inventor: Kwan Woo PARK, Seoul (KR)

(73) Assignee: AIMATICS CO., LTD, Seoul (KR)

(21) Appl. No.: 19/116,276

(22) PCT Filed: Sep. 18, 2023
(86) PCT No.: PCT/KR2023/014081

§ 371 Date: Mar. 27, 2025

(30) Foreign Application Priority Data
Sep. 27, 2022 (KR) 10-2022-0122705

(51) Int. Cl. G06V 20/40; G06V 10/774; G06V 20/56

(52) U.S. Cl. CPC G06V 20/44; G06V 10/774; G06V 20/56

(57) ABSTRACT

Disclosed are an event detection method and device based on a memory-linkable hierarchical structure. The method includes a first event processing step including a step of collecting a real-time driving video from a running vehicle, on a terminal, and a step of applying the real-time driving video to a first event detection model to generate first event information about driving of the vehicle; and a second event processing step including a step of collecting the first event information, on the terminal, and a step of applying the first event information to a second event detection model to generate second event information about driving of the vehicle

### TECHNICAL FIELD

The present disclosure relates to a technology for determining the type of the first-person event, and more specifically, to a system capable of effectively detecting various events in a memory-linkable hierarchical structure from real-time driving videos collected from multiple cameras in a vehicle.

### BACKGROUND ART

With the development of digital technology, various sensors and devices are being applied to vehicles. For example, cameras installed in vehicles record videos around the vehicles, providing significant assistance in identifying the cause of an event such as a traffic accident. However, most vehicle-related videos are used for recording driving situations rather than for real-time analysis, and their utilization for real-time situation analysis and risk prediction remains limited.

In other words, if various abnormal phenomena occurring while a vehicle is driving can be accurately detected in advance, it is possible to warn a driver in advance or prevent a significant number of accidents through the vehicle's own automatic control function. To this end, research on predicting abnormal situations in advance using video information collected from various cameras installed in vehicles is being increasingly conducted using artificial intelligence technology.

### PRIOR ART DOCUMENT

### Patent Document

Korean Patent No. 10-2105954 (2020.04.23.)

### DETAILED DESCRIPTION OF INVENTION

### Technical Problems

An embodiment of the present disclosure provides a system that can detect key events in a video by analyzing and learning features appearing in an event video using a deep learning model, and includes an efficient processing structure for a long-term event using a hierarchical structure.

### Technical Solution

Among embodiments, an event detection method based on a memory-linkable hierarchical structure includes a first event processing step including a step of collecting a real-time driving video from a running vehicle, on a terminal, and a step of applying the real-time driving video to a first event detection model to generate first event information about driving of the vehicle; and a second event processing step including a step of collecting the first event information on the terminal, and a step of applying the first event information to a second event detection model to generate second event information about driving of the vehicle.

The second event information may correspond to upper-level hierarchy information derived by forming a hierarchical structure with the first event information and using the first event information as lower-level information of the hierarchical structure.

The first event information may include an accident event, a bump event, an anomaly motion event, and a dangerous event, as abnormal events that occur during the driving of the vehicle.

Each of the first and second event processing steps may include the steps of transmitting and storing the real-time driving video or the first event information to and in a cloud server, on the terminal; generating learning data for additional learning of an event detection model of a corresponding step from the real-time driving video or the first event information, on the cloud server; additionally learning the event detection model of the corresponding step by learning the learning data, on the cloud server; and receiving and updating the event detection model of the corresponding step, which is additionally learned from the cloud server, on the terminal.

The step of generating the learning data may include the steps of generating the learning data by receiving label information about the real-time driving video or the first event information from a user terminal; and generating the learning data through auto labeling using the event detection model of the corresponding step.

The second event processing step comprises the step of generating the second event information for each second event section that is extended for at least one of a spatial domain and a time domain, rather than a first event section in which the first event information is collected, according to the hierarchical structure formed based on the spatial domain and the time domain.

The method may further include a hierarchical structure extension step of repeatedly extending the hierarchical structure by generating third event information corresponding to upper-level hierarchy information of the second event information, using the second event information as lower-level hierarchy information of the hierarchical structure.

The hierarchical structure extension step may include the step of selectively generating event information of each event section from the real-time driving video through an event detection model of each event processing step, which is formed through repeated extension of the hierarchical structure.

Among embodiments, an event detection device based on a memory-linkable hierarchical structure includes a first event processing part operating on a terminal, and performing a step of collecting a real-time driving video from a running vehicle and a step of applying the real-time driving video to a first event detection model to generate first event information about driving of the vehicle; and a second event processing part operating on the terminal, and performing a step of collecting the first event information and a step of applying the first event information to a second event detection model to generate second event information about driving of the vehicle,

### Effect of Invention

The disclosed technology can have the following effects. However, it is not intended to mean that a specific embodiment should include all of the following effects or only the following effects, and the scope of the disclosed technology should not be understood as being limited thereby.

The event detection method and device based on the memory-linkable hierarchical structure according to an embodiment of the present disclosure can determine the type of a first-person event by receiving videos acquired from multiple cameras in a vehicle.

The event detection method and device based on the memory-linkable hierarchical structure according to an embodiment of the present disclosure can provide an efficient hierarchy processing structure for short-term, long-term and ultra-long-term memories depending on the type and usability of the event.

Therefore, the present disclosure can distinguish between vehicle events such as speed bumps or potholes and accidents caused by collisions with vehicles or facilities, detect an event requiring a long-term memory, such as retaliatory driving, solve problems requiring an ultra-long-term memory, such as a driver's driving score or habits, and provide information for the efficient management of vehicle control, driver information, and event situations.

### BRIEF DESCRIPTION OF THE DRAWING

FIG. 1 is a diagram illustrating an event detection system according to the present disclosure.

FIG. 2 is a diagram illustrating the system configuration of a terminal of FIG. 1.

FIG. 3 is a diagram illustrating the functional configuration of an event detection device according to the present disclosure.

FIG. 4 is a flowchart illustrating an event detection method based on a memory-linkable hierarchical structure according to the present disclosure.

FIG. 5 is a diagram illustrating a hierarchical structure for efficient processing of an event according to the present disclosure.

FIG. 6 is a diagram illustrating an embodiment of an event detection process according to the present disclosure.

FIG. 7 is a diagram illustrating the operation of an event detection model according to the present disclosure.

FIG. 8 is a diagram illustrating an embodiment of an event hierarchy according to the present disclosure.

### BEST MODE FOR CARRYING OUT THE INVENTION

The description of the present disclosure is only an example for structural or functional explanation, and the scope of the present disclosure should not be construed as limited by the embodiments described herein. In other words, the embodiments can be modified in various ways and can have various forms, and the scope of the present disclosure should be understood to include equivalents that can realize the technical idea. In addition, the purpose or effect presented in the present disclosure does not mean that a specific embodiment should include all or only such effects, so the scope of the present disclosure should not be understood as limited thereby.

Meanwhile, the meaning of the terms described in the present specification should be understood as follows.

The terms such as “first”, “second”, etc. are intended to distinguish one component from another component, and the scope of the present disclosure should not be limited by these terms. For example, a first component may be named as a second component, and similarly, the second component may also be named as the first component.

When it is described that a component is “connected” to another component, it should be understood that one component may be directly connected to another component, but that other components may also exist between them. On the other hand, when it is described that a component is “directly connected” to another component, it should be understood that there is no other component between them. Meanwhile, other expressions that describe the relationship between components, such as “between” and “immediately between” or “neighboring” and “directly neighboring” should be interpreted similarly.

Singular expressions should be understood to include plural expressions unless the context clearly indicates otherwise, and terms such as “comprise or include” or “have” are intended to specify the existence of implemented features, numbers, steps, operations, components, parts, or combinations thereof, but should be understood as not precluding the possibility of the existence or addition of one or more other features, numbers, steps, operations, components, parts, or combinations thereof.

The identification symbols (e.g., a, b, c, etc.) used in each step are for convenience of explanation and do not indicate the sequence of the steps. Unless a specific order is explicitly stated in the context, the steps may occur in a different order than stated. That is, the steps may occur in the stated order, be performed substantially simultaneously, or be performed in the reverse order.

The present disclosure may be implemented as a computer-readable code on a computer-readable recording medium, which includes all types of storage devices that store data readable by a computer system. Examples of the computer-readable recording medium include ROM, RAM, CD-ROM, magnetic tape, floppy disks, optical data storage media, etc. Further, the computer-readable recording medium can be distributed across computer systems connected via a network, allowing the computer-readable code to be stored and executed in a distributed manner.

Unless otherwise defined, all terms used herein have the same meaning as commonly understood by one of ordinary skill in the art to which the present disclosure belongs. It will be further understood that terms used herein should be interpreted as having a meaning that is consistent with their meaning in the context of this specification and the relevant art and will not be interpreted in an idealized or overly formal sense unless expressly so defined herein.

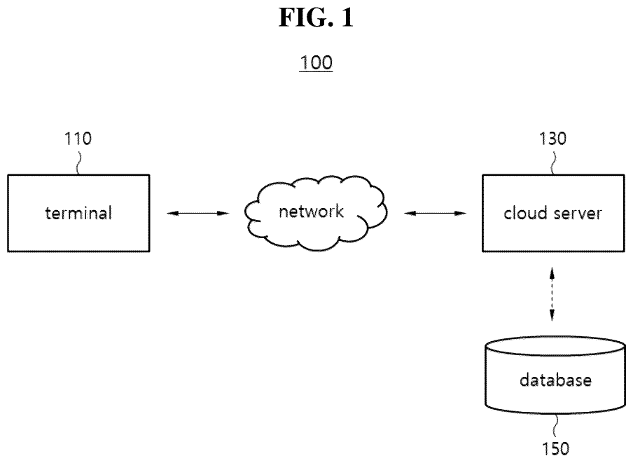

FIG. 1 is a diagram illustrating an event detection system according to the present disclosure.

Referring to FIG. 1, the event detection system 100 may include a terminal 110, a cloud server 130, and a database 150 as a configuration for performing an event detection method based on a memory-linkable hierarchical structure according to the present disclosure. Here, for convenience of explanation, the terminal 110, the cloud server 130, and the database 150 are described as independent devices, but the present disclosure is not necessarily limited thereto. Of course, at least two different devices may be integrated and implemented as one device according to various embodiments for event detection.

The terminal 110 may correspond to a computing device that may generate and store a video and transmit the video to the cloud server 130. In one embodiment, the terminal 110 may be implemented to include a camera module that enables the image and video to be captured. For example, the terminal 110 may be implemented as a camera sensor, black box, etc. installed in a vehicle. Further, the terminal 110 may be implemented as a smart phone, a tablet PC, or a laptop, but the present disclosure is not necessarily limited thereto. Of course, the terminal may be implemented as various devices including a camera.

Further, the terminal 110 may be implemented as one device constituting the event detection system 100 according to the present disclosure. Furthermore, the terminal 110 may be connected to the cloud server 130 via a network. If necessary, a plurality of terminals 110 may be implemented to be simultaneously connected to one cloud server 130.

The cloud server 130 may be implemented as a server corresponding to a computer or program that may receive and store data transmitted from the terminal 110 and may generate and store information necessary for event detection through data analysis. For example, the cloud server 130 may generate learning data for the event detection model based on vehicle driving video or detected event information, which is captured by the terminal 110. The cloud server 130 may perform additional learning on the event detection model using the learning data, and distribute the updated event detection model to each terminal 110. To this end, the cloud server 130 may be connected to the terminal 110 via a wired network or a wireless network such as Bluetooth, WiFi, LTE, etc., and may transmit and receive data with the terminal 110 via the network.

In addition, the cloud server 130 may be implemented to operate in a cloud environment, and may be implemented to operate in connection with an independent external system (not shown in FIG. 1) according to various embodiments for performing the event detection method according to the present disclosure. For example, the cloud server 130 may operate as the server in the cloud environment, and may preferably be implemented to have better performance than the operation performance of the terminal 110.

Meanwhile, each of the terminal 110 and the cloud server 130 may include a plurality of modules that are implemented independently to perform related operations, and may be implemented to include a control module that manages control and data flow for the plurality of modules.

The database 150 may correspond to a storage device that stores various pieces of information required during the operation of the cloud server 130. For example, the database 150 may store short-term, long-term, and ultra-long-term event information received from at least one terminal 110, or store information about a learning algorithm and learning data for additional learning of the event detection model. However, without being necessarily limited thereto, the cloud server 130 may store information collected or processed in various forms in the process of performing the event detection method based on the memory-linkable hierarchical structure according to the present disclosure in conjunction with the terminal 110.

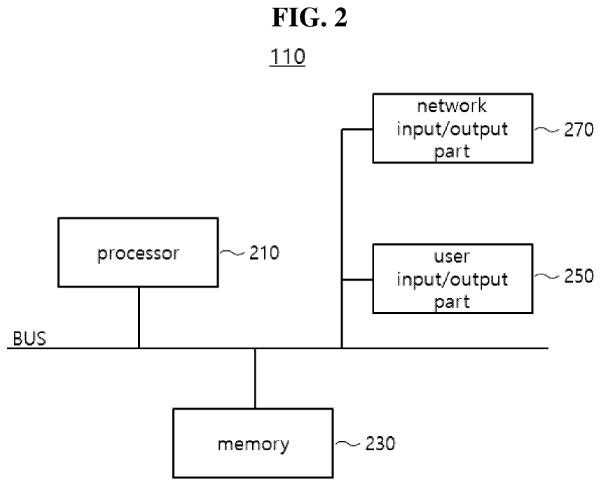

FIG. 2 is a diagram illustrating the system configuration of the terminal of FIG. 1.

Referring to FIG. 2, the terminal 110 may include a processor 210, a memory 230, a user input/output part 250, and a network input/output part 270.

The processor 210 may execute a procedure for performing the event detection method based on the memory-linkable hierarchical structure according to an embodiment of the present disclosure, manage the memory 230 that is read or written in the process, and schedule a synchronization time between a volatile memory and a non-volatile memory in the memory 230. The processor 210 may control the overall operation of the terminal 110 and may be electrically connected to the memory 230, the user input/output part 250, and the network input/output part 270 to control the data flow between them. The processor 210 may be implemented as the CPU (Central Processing Unit) or GPU (Graphics Processing Unit) of the terminal 110 or the cloud server 130.

The memory 230 may include an auxiliary memory device that is implemented as the non-volatile memory such as an SSD (Solid State Disk) or an HDD (Hard Disk Drive) and is used to store all data required for the terminal 110, and may include a main memory device implemented as the volatile memory such as a RAM (Random Access Memory). Further, the memory 230 may be executed by the electrically connected processor 210 to store a set of commands that execute the memory-linkable hierarchical structure-based event detection method according to the present disclosure.

The user input/output part 250 may include an environment for receiving user input and an environment for outputting specific information to the user, and may include, for example, an input device including an adapter such as a touch pad, a touch screen, an on-screen keyboard, or a pointing device, and an output device including an adapter such as a monitor or a touch screen. In one embodiment, the user input/output part 250 may correspond to a computing device connected via remote access. In such a case, the terminal 110 may correspond to an independent node of the network to which the computing device is connected.

The network input/output part 270 may provide a communication environment for connecting to other devices through the network, and may include an adapter for communication such as a LAN (Local Area Network), a MAN (Metropolitan Area Network), a WAN (Wide Area Network), and a VAN (Value Added Network), for example. Further, the network input/output part 270 may be implemented to provide a short-range communication function such as WiFi or Bluetooth or a wireless communication function of 4G or higher for wireless transmission of data.

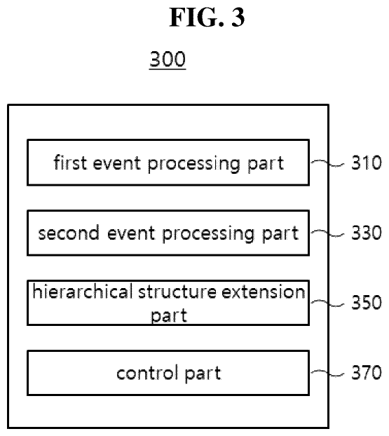

FIG. 3 is a diagram illustrating the functional configuration of an event detection device according to the present disclosure.

Referring to FIG. 3, the event detection device 300 may include a first event processing part 310, a second event processing part 330, a hierarchical structure extension part 350, and a control part 370.

At this time, embodiments of the present disclosure do not have to include all of the above functional configurations at the same time, and may be implemented by omitting some of the above configurations or selectively including some or all of the above configurations depending on each embodiment. In addition, one embodiment of the present disclosure may be implemented as an independent module that selectively includes some of the above configurations, and may perform the event detection method based on the memory-linkable hierarchical structure according to the present disclosure through linkage between modules. Below, the operation of each component will be described in detail.

The first event processing part 310 operates on the terminal 110, and may perform the steps of collecting a real-time driving video from a driving vehicle and applying the real-time driving video to a first event detection model to generate first event information about the vehicle's driving. The first event processing part 310 may be composed of a plurality of modules that independently perform each step.

To be more specific, the first event processing part 310 may be implemented within the terminal 110 that is installed and operated in the vehicle, and may collect vehicle surrounding videos collected through the terminal 110 during the driving of the vehicle as real-time driving videos. For example, the vehicle surrounding videos may include a front-view video in the vehicle driving direction, a rear-view video in the opposite direction of travel, and side-view videos of the vehicle's lateral directions. The first event processing part 310 may directly link with the camera module inside the terminal 110 to directly collect videos captured by the camera module.

Further, the first event processing part 310 may store the collected real-time driving video in the memory, and input the real-time driving video into a pre-built first event detection model to obtain first event information. Here, the first event detection model may correspond to a deep learning model that receives the real-time driving video as input and generates first event information detected in the real-time driving video as output. At this time, each frame image of the driving video may be used as input data according to the definition of the first event detection model, but the present disclosure is not limited thereto.

In one embodiment, the first event information may include an accident event, a bump event, an anomaly motion event, and a dangerous event, which are abnormal events that occur during the driving of the vehicle. The first event information may correspond to event information derived as the analysis result of real-time driving video, and may be detected based on the minimum time and spatial unit sections in event detection.

For example, the first event information is the short-term event and may include events that have a low probability of occurring during the normal driving of the vehicle. The accident event may include events related to a collision between vehicles or a collision with an external obstacle, and the bump event may include events caused by a road step, a speed bump, and a small obstacle. Further, the anomaly motion event may include events caused by the abnormal driving operation such as rapid acceleration, sudden stops, and sharp turns. The dangerous event may include events related to dangerous driving conditions such as lane departure, rain, snow, fog, etc.

That is, the first event may correspond to a short-term event with the smallest time unit and a localized event with the narrowest spatial unit. Therefore, the first event detection model may correspond to a short-term event detection model that is detected based on the smallest unit in time and space domains.

In one embodiment, the first event processing part 310 may perform the step of transmitting the real-time driving video or first event information on the terminal 110 to the cloud server 130 and storing it, the step of generating learning data for additional learning of the event detection model of the corresponding step from the real-time driving video or first event information on the cloud server 130, the step of learning data for learning on the cloud server 130 and additionally learning the event detection model of the corresponding step, and the step of receiving the event detection model of the corresponding step, which has been additionally learned, from the cloud server 130 on the terminal 110 and updating it.

To be more specific, the first event processing part 310 may transmit the real-time driving video collected from the terminal 110 to the cloud server 130 connected to the terminal 110. The cloud server 130 may receive and store the data and perform the additional learning of the first event detection model. That is, the cloud server 130 may perform a labeling operation to generate driving data for learning based on the real-time driving video in conjunction with the first event processing part 310. The labeling operation may correspond to the operation of assigning a label to the learning data extracted from the real-time driving video. Further, the cloud server 130 may generate the driving data for learning from label information of the first event information detected by the first event detection model.

Subsequently, the cloud server 130 may additionally learn the driving data for learning through the first event detection model, and the first event detection model updated by additional learning may be transmitted from the cloud server 130 to the terminal 110. The terminal 110 may receive the additionally learned first event detection model and update the previously stored first event detection model with the additionally learned model.

In one embodiment, the first event processing part 310 may perform the step of generating the driving data for learning by receiving label information about the real-time driving video from the user terminal, in the step of generating the learning data, and the step of generating the driving data for learning through auto labeling using the first event detection model. Meanwhile, the second event processing part 330 may also generate short-term data for learning in the same manner. That is, the second event processing part 330 may receive label information about the first event information from the user terminal or generate the short-term data for learning through auto labeling using the second event detection model.

The second event processing part 330 may operates on the terminal 110, and perform the steps of collecting the first event information and applying the first event information to the second event detection model to generate second event information about the driving of the vehicle. Here, the second event information may correspond to upper-level information derived by forming a hierarchical structure with the first event information and using the first event information as lower-level information of the hierarchical structure. That is, the second event processing part 330 may form an efficient hierarchical processing structure for event detection in conjunction with the first event processing part 310.

For example, when the first event processing part 310 detects the collision event information, which is the first event information, in a 1-second video segment from the vehicle driving video, the second event processing part 330 may generate second event information, such as a retaliatory driving event or a chain collision event, based on collision event information detected in a video segment extended to 10 seconds.

In one embodiment, the second event processing part 330 may perform an update operation for the event detection model, which is performed in the first event processing part 310, and a specific operation thereof may be the same as the operation for the first event processing part 310.

In one embodiment, the second event processing part 330 may generate second event information for each second event section that is extended for at least one of the spatial domain and the time domain, rather than a first event section in which the first event information is collected, according to the hierarchical structure formed based on the spatial domain and the time domain. For example, the first event processing part 310 may detect the first event in the driving video in 10-second units in the time domain, and the second event processing part 330 may detect the second event based on the first events detected in 5-minute units. That is, the second event information may correspond to event information detected as a result of integrating the first event information. Event detection in the spatial domain may be performed in the same way as event detection in the time domain, and its description will be omitted herein.

The hierarchical structure extension part 350 may repeatedly extend the hierarchical structure by using second event information as lower-level information of the hierarchical structure and generating third event information corresponding to upper-level information of the second event information. The hierarchical structure extension part 350 may operate on the terminal 110, but may also operate on the cloud server 130 as needed without being necessarily limited thereto. That is, the hierarchical structure of event detection may be selectively extended through iteration.

Further, the hierarchical structure of event detection may be implemented in conjunction with the memory structure. Thus, event information collected in each event detection step may be independently stored and managed in a memory area of the corresponding hierarchical structure.

For example, a third event processing part may be added based on the event detection structure between the first event processing part 310 and the second event processing part 330. The third event processing part may perform the operation of generating third event information corresponding to upper level information using the second event information detected by the second event processing part 330 as lower level information.

That is, when the first event information is the short-term event and the second event information is the long-term event, the third event information may correspond to the ultra-long-term event. Further, the first event information may be stored in the short-term memory area, the second event information may be stored in the long-term memory area, and the third event information may be stored in the ultra-long-term memory area. In this way, the hierarchical structure extension part 350 may extend the hierarchical structure by repeatedly adding an event processing step of an upper level to the existing hierarchical structure.

In one embodiment, the hierarchical structure extension part 350 may selectively generate event information of each event section from the real-time driving video through the event detection model of each event processing step formed through repeated extension of the hierarchical structure. For example, the first to third event processing parts are sequentially connected, forming the hierarchical structure that enables the detection of the short-term event, the long-term event, and the ultra-long-term event related to the vehicle driving video. The hierarchical structure extension part 350 may provide selective event detection results through the operation of a specific event processing step according to the hierarchical structure.

The control part 370 controls the overall operation of the event detection device 300 and may manage the control flow or data flow between the first event processing part 310, the second event processing part 330, and the hierarchical structure extension part 350.

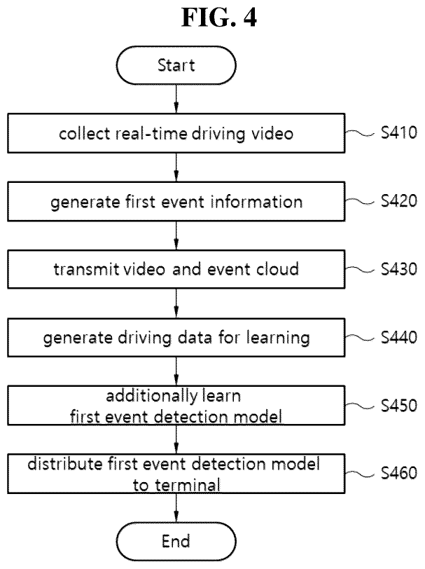

FIG. 4 is a flowchart illustrating the event detection method based on the memory-linkable hierarchical structure according to the present disclosure.

Referring to FIG. 4, the event detection device 300 may collect the real-time driving video from the driving vehicle on the terminal 110 through the first event processing part 310 (step S410). The event detection device 300 may generate the first event information about the driving of the vehicle by applying the real-time driving video to the first event detection model on the terminal 110 through the first event processing part 310 (step S420). The event detection device 300 may transmit the real-time driving video and first event information to the cloud server 130 on the terminal 110 through the first event processing part 310 (step S430).

Further, the event detection device 300 may generate driving data for learning from the real-time driving video or first event information on the cloud server 130 through the first event processing part 310 (step S440). The event detection device 300 may update the first event detection model by additionally learning the driving data on the cloud server 130 through the first event processing part 310 (step S450). The event detection device 300 may distribute the updated first event detection model to the terminal 110 on the cloud server 130 through the first event processing part 310 so that the event detection model is updated in each terminal 110 (step S460).

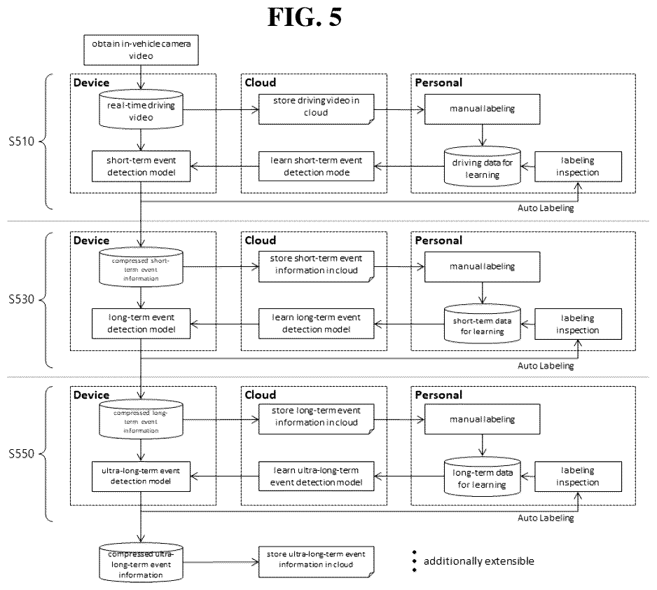

FIG. 5 is a diagram illustrating a hierarchical structure for efficient processing of an event according to the present disclosure.

Referring to FIG. 5, the event detection device 300 may construct an efficient hierarchical processing structure corresponding to short-term, long-term, and ultra-long-term memories depending on the type and usability of the event. That is, the event detection device 300 may perform hierarchical event detection from the real-time driving video collected in the driving process of the vehicle.

In FIG. 5, in the short-term event processing step S510, operations related to real-time driving video collection and short-term event detection may be performed through the terminal 110 based on the linkage between the terminal 110 and the cloud server 130, and operations related to the collection of driving data for learning and the additional learning of the short-term event detection model may be performed through the cloud server 130.

Further, in the long-term event processing step S530, based on the short-term event information generated in the short-term event processing step S510, operations related to the collection of compressed short-term event information and the detection of long-term events may be performed through the terminal 110, and operations related to the collection of the short-term learning data and the additional learning of the long-term event detection model may be performed through the cloud server 130.

Furthermore, in the ultra-long-term event processing step S550, operations related to the collection of compressed long-term event information and the detection of ultra-long-term events may be performed through the terminal 110 based on the long-term event information generated in the long-term event processing step S530, and operations related to the collection of long-term learning data and additional learning of the ultra-long-term event detection model may be performed through the cloud server 130.

In one embodiment, the event detection device 130 may logically divide the memory 230 on the terminal 110 into a short-term memory area, a long-term memory area, and an ultra-long-term memory area according to the hierarchical structure. In this case, the first event processing part 310 may operate in conjunction with the short-term memory area, the second event processing part 330 may operate in conjunction with the long-term memory area, and the third event processing part 330 may operate in conjunction with the ultra-long-term memory area.

Further, the event detection device 130 may be implemented to operate in conjunction with independent instances created by the cloud server 130. In this case, the first event processing part 310 may operate in conjunction with a short-term event detection instance, the second event processing part 330 may operate in conjunction with a long-term event detection instance, and the third event processing part may operate in conjunction with an ultra-long-term event detection instance.

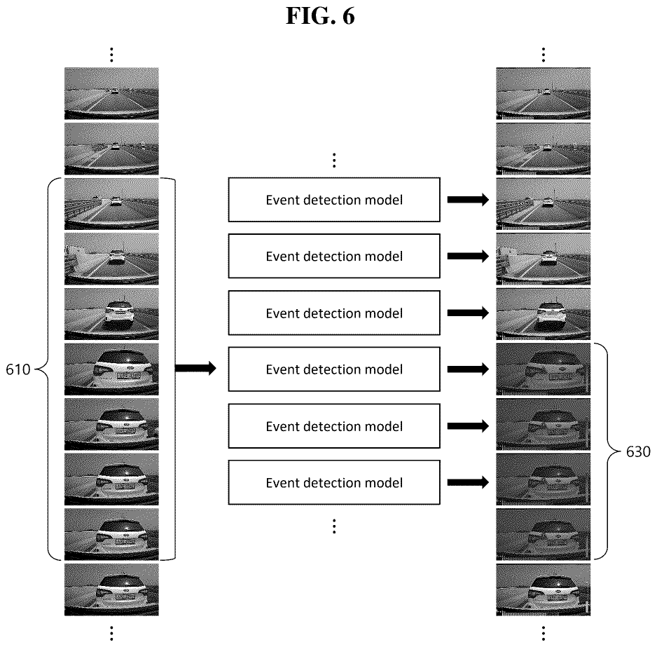

FIG. 6 is a diagram illustrating an embodiment of an event detection process according to the present disclosure.

Referring to FIG. 6, the event detection device 300 may effectively detect events occurring during vehicle driving through the event detection model with the hierarchical structure.

For example, in FIG. 6, the event detection device 300 may divide real-time vehicle driving video into preset time intervals. Segmented videos 610 may be input into a pre-built event detection model to generate an output regarding whether an event has occurred. That is, the event detection model may provide as output whether an event occurred for each segmented video received as input.

Event videos 630 determined to have an event by the event detection model may then be transferred to an upper-level event detection model and used for event detection over a longer time interval. In FIG. 6, the dangerous event may occur based on a distance from a vehicle ahead among the segmented videos 610, and the event detection device 300 may transmit information about four event videos 630 in which the dangerous event is detected among the six segmented videos 610 to the next step, enabling upper-level event detection to be performed.

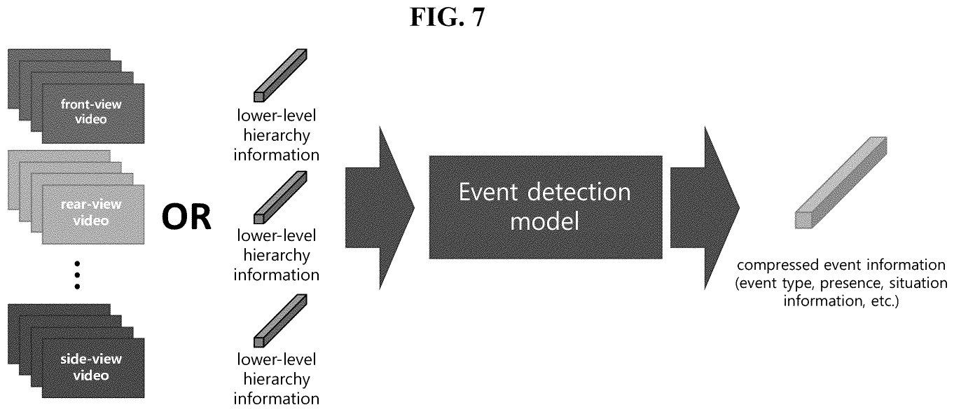

FIG. 7 is a diagram illustrating the operation of an event detection model according to the present disclosure.

Referring to FIG. 7, the event detection device 300 may perform end-to-end learning and event detection by inputting videos recorded over a certain period of time while the vehicle is driving. The event detection device 300 may learn spatial and temporal domain features present in the event video.

For example, the event detection device 300 may progressively learn hierarchically extended features in the spatial domain based on front, rear, and side-view videos acquired through multiple cameras in the vehicle. Thus, the event detection device 300 may effectively distinguish between accident-like events, such as speed bumps and potholes, and actual accident events within the video.

In addition, the event detection device 300 may obtain compressed event information as upper level information through the event detection model based on lower level information extracted from the video. At this time, the compressed event information may include event type, presence, and situation information.

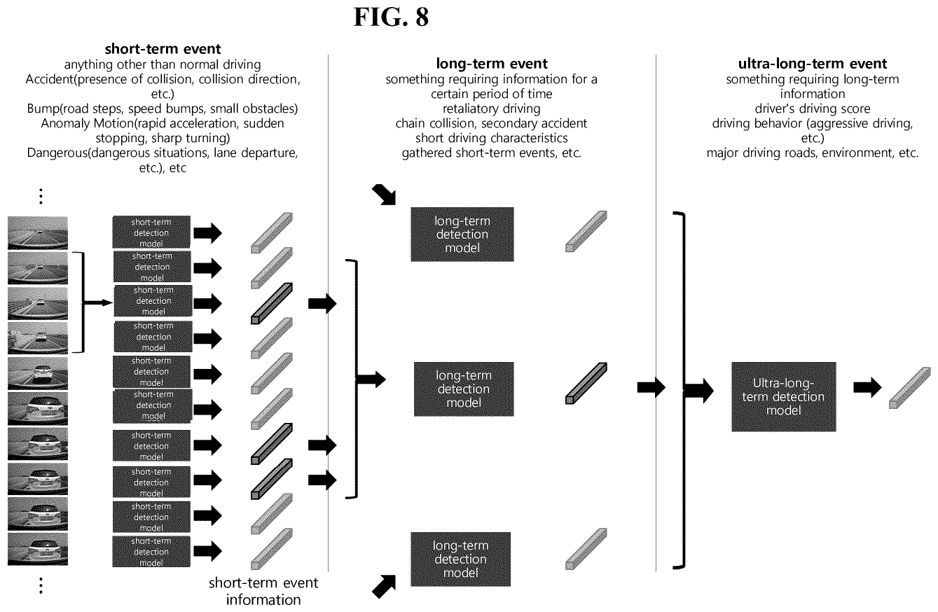

FIG. 8 is a diagram illustrating an embodiment of an event hierarchy according to the present disclosure.

Referring to FIG. 8, the event detection device 300 may effectively detect key events in the real-time driving video by analyzing and learning features appearing in the event video using the deep learning model. In particular, the event detection device 300 may build an efficient processing structure for the long-term event by using the hierarchical structure.

In FIG. 8, the event detection device 300 may detect events other than general driving situations as the short-term event information from the real-time driving video through the short-term detection model. For example, the short-term event information may include Accident (the presence of collision, the direction of collision, etc.), Bump (road steps, speed bumps, small obstacles), Anomaly Motion (rapid acceleration, sudden stop, sharp turn), Dangerous (dangerous situation, lane departure), etc.

Further, the event detection device 300 may detect events that require information for a certain period of time as the long-term event information from the short-term event information through the long-term detection model. For example, the long-term event information may include retaliatory driving, pileups, secondary accidents, short driving characteristics, and gathered short-term events.

Furthermore, the event detection device 300 may detect events that require long-term information as the ultra-long-term event information from the long-term event information through the ultra-long-term detection model. For example, the ultra-long-term event information may include a driver's driving score, driving behavior (aggressive driving, etc.), major driving roads and environments, etc.

Although the present disclosure has been described above with reference to preferred embodiments, it will understood by those skilled in the art that various modifications and changes may be made to the present disclosure without departing from the idea and scope of the present disclosure as set forth in the following claims.

[DESCRIPTION OF REFERENCE NUMERALS]

| | |
|---|---|
| 100: event detection system | |
| 110: terminal | 130: cloud server |
| 150: database | |
| 210: processor | 230: memory |
| 250: user input/output part | 270: network input/output part |
| 300: event detection device | |
| 310: first event processing part | 330: second event processing part |
| 350: hierarchical structure extension | 370: control part |
| part | |

1. An event detection method based on a memory-linkable hierarchical structure, the method comprising:
a first event processing step including a step of collecting a real-time driving video from a running vehicle, on a terminal, and a step of applying the real-time driving video to a first event detection model to generate first event information about driving of the vehicle; and
a second event processing step including a step of collecting the first event information on the terminal, and a step of applying the first event information to a second event detection model to generate second event information about driving of the vehicle,
wherein the second event information corresponds to upper-level hierarchy information derived by forming a hierarchical structure with the first event information and using the first event information as lower-level information of the hierarchical structure.

2. The method of claim 1, wherein the first event information comprises an accident event, a bump event, an anomaly motion event, and a dangerous event, as abnormal events that occur during the driving of the vehicle.

3. The method of claim 1, wherein each of the first and second event processing steps comprises the steps of:
transmitting and storing the real-time driving video or the first event information to and in a cloud server, on the terminal;
generating learning data for additional learning of an event detection model of a corresponding step from the real-time driving video or the first event information, on the cloud server;
additionally learning the event detection model of the corresponding step by learning the learning data, on the cloud server; and
receiving and updating the event detection model of the corresponding step, which is additionally learned from the cloud server, on the terminal.

4. The method of claim 3, wherein the step of generating the learning data comprises the steps of:
generating the learning data by receiving label information about the real-time driving video or the first event information from a user terminal; and
generating the learning data through auto labeling using the event detection model of the corresponding step.

5. The method of claim 1, wherein the second event processing step comprises the step of:
generating the second event information for each second event section that is extended for at least one of a spatial domain and a time domain, rather than a first event section in which the first event information is collected, according to the hierarchical structure formed based on the spatial domain and the time domain.

6. The method of claim 1, further comprising:
a hierarchical structure extension step of repeatedly extending the hierarchical structure by generating third event information corresponding to upper-level hierarchy information of the second event information, using the second event information as lower-level hierarchy information of the hierarchical structure.

7. The method of claim 6, wherein the hierarchical structure extension step comprises the step of:
selectively generating event information of each event section from the real-time driving video through an event detection model of each event processing step, which is formed through repeated extension of the hierarchical structure.

8. An event detection device based on a memory-linkable hierarchical structure, the device comprising:
a first event processing part operating on a terminal, and performing a step of collecting a real-time driving video from a running vehicle and a step of applying the real-time driving video to a first event detection model to generate first event information about driving of the vehicle; and
a second event processing part operating on the terminal, and performing a step of collecting the first event information and a step of applying the first event information to a second event detection model to generate second event information about driving of the vehicle,
wherein the second event information corresponds to upper-level hierarchy information derived by forming a hierarchical structure with the first event information and using the first event information as lower-level information of the hierarchical structure.
